(19) United States
(12) Patent Application Publication
(10) Pub. No.: US 2022/0028147 A1
(43) Pub. Date: Jan. 27, 2022

(54) OPERATING ANIMATION CONTROLS USING EVALUATION LOGIC

(71) Applicant: Weta Digital Limited, Wllington (NZ)

(72) Inventors: Niall J. Lenihan, Wellington (NZ); Sander van der Steen, Wellington (NZ); Florian Deconinck, Wellington (NZ); Richard Chi Lei, Wellington (NZ); Andrew R. Phillips, Wellington (NZ); Leo Hutson, Wellington (NZ); John McCarten, Wellington (NZ); Jamie McCarter, Wellington (NZ); Mark Davies, Wellington (NZ); Michael Forot, Wellington (NZ)

(73) Assignee: Weta Digital Limited, Wllington (NZ)

(21) Appl. No.: 17/323,945

(22) Filed: May 18, 2021

Related U.S. Application Data
(60) Provisional application No. 63/056,426, filed on Jul. 24, 2020.

(51) Int. Cl. G06T 13/40; G06T 13/80; G06F 3/0486; G06F 16/21

(52) U.S. Cl. CPC G06T 13/40; G06T 13/80; G06T 2213/08; G06F 16/219; G06T 2200/24; G06F 3/0486

(57) ABSTRACT

An aspect provides a computer-implemented method for operating animation controls associated with an animation control rig. The method comprises determining a node graph used to operate one or more animation controls; receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead; processing the control data inputs using the executable code object; and operating the one or more animation controls with respect to the single execution instruction in response to the control data inputs.

### CROSS REFERENCES TO RELATED APPLICATIONS

This application claims the benefit of U.S. Provisional Patent Application Ser. No. 63/056,426, entitled METHODS AND SYSTEMS FOR OPERATING ANIMATION CONTROLS AND CONSTRUCTING EVALUATION LOGIC, filed on Jul. 24, 2020, which is hereby incorporated by reference as if set forth in full in this application for all purposes.

### FIELD OF THE INVENTION

The present disclosure generally relates to methods and systems for operating animation controls and for constructing evaluation logic associated with animation. The disclosure more particularly relates to techniques for generating animation sequence data in a visual content generation system. The methods and systems disclosed below are not limited to animation and visual content systems. The data processing techniques disclosed below, for example, may be applied to different fields.

### BACKGROUND

Visual content generation systems are used to generate imagery in the form of still images and/or video sequences of images. The still images and/or video sequences of images includes live action scenes obtained from a live action capture system, computer generated scenes obtained from an animation creation system, or a combination thereof.

An animation artist is provided with tools that allow them to specify what is to go into that imagery. Where the imagery includes computer generated scenes, the animation artist may use various tools to specify the positions in a scene space such as a three-dimensional coordinate system of objects. Some objects are articulated, having multiple limbs and joints that are movable with respect to each other.

The animation artist may retrieve a representation of an articulated object and generate an animation sequence movement of the articulated object, or part thereof. Animation sequence data representing an animation sequence may be stored in data storage, such as animation sequence storage described below.

Animation sequence data might be in the form of time series of data for control points of an articulated object having attributes that are controllable. Generating animation sequence data has the potential to be a complicated task when a scene calls for animation of an articulated object.

It is an object of at least preferred embodiments to address at least some of the aforementioned disadvantages. An additional or alternative object is to at least provide the public with a useful choice.

### SUMMARY

In accordance with an aspect, a computer-implemented method for operating animation controls associated with an animation control rig comprises: determining a node graph used to operate one or more animation controls; receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead; processing the control data inputs using the executable code object; and operating the one or more animation controls with respect to the single execution instruction in response to the control data inputs.

The term ‘comprising’ as used in this specification means ‘consisting at least in part of’. When interpreting each statement in this specification that includes the term ‘comprising’, features other than that or those prefaced by the term may also be present. Related terms such as ‘comprise’ and ‘comprises’ are to be interpreted in the same manner

The computer-implemented method of claim 1, wherein at least one node of the node graph comprises a function employed to check a data type.

In an embodiment at least one node of the node graph comprises a function employed to check a data version.

In an embodiment the method further comprises, in response to a request to break the executable code object into two or more segments, determining at least one segmentation point that reduces an increase in processing time incurred by segmenting the executable code object.

In an embodiment the executable code object is received via a User Interface (UI) widget.

In an embodiment the executable code object is received within the UI widget by one or more of: a drag-and-drop action, operation of an input device.

In an embodiment the executable code object is received within the UI widget by retrieving, from a storage device, data representing the executable code object.

### BRIEF DESCRIPTION OF THE DRAWINGS

Various embodiments in accordance with the present disclosure will be described with reference to the drawings, in which:

FIG. 1 shows an example of a control rig configured to enable an artist to create animation sequence data.

FIG. 2 shows examples of animation control points associated with the control rig of FIG. 1.

FIG. 3 shows an example of a user interface that may be used to author evaluation logic associated with the animation control rig of FIG. 1.

FIG. 4 shows an example of a hierarchical node graph suitable for implementing the control rig of FIG. 1.

FIG. 5 shows an example of a method for operating animation controls associated with the animation control rig of FIG. 1.

FIG. 6 is a block diagram illustrating an example computer system upon which computer systems disclosed below may be implemented.

FIG. 7 illustrates an example visual content generation system as might be used to generate imagery in the form of still images and/or video sequences of images.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The present disclosure generally relates to methods and systems for operating animation controls and for constructing evaluation logic associated with developing animation content. The disclosure more particularly relates to techniques for generating animation sequence data in a visual content generation system.

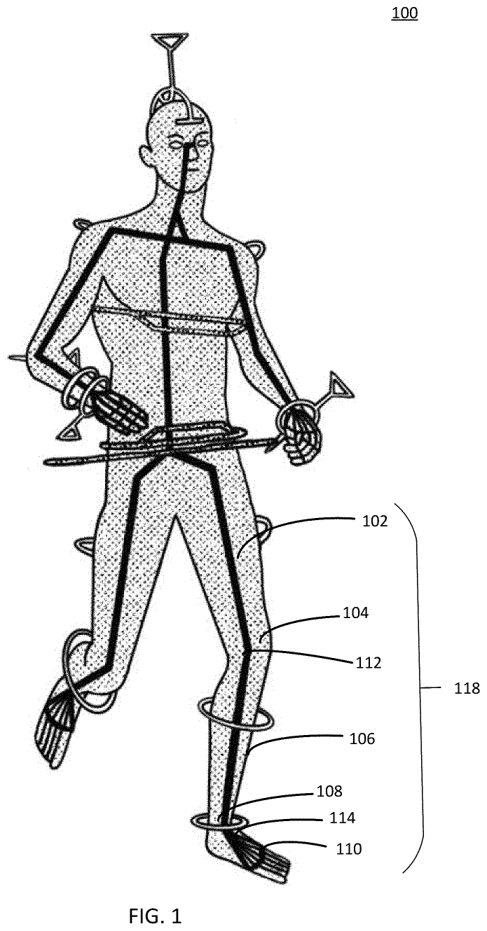

FIG. 1 shows an example of a control rig 100, or animated skeleton. Control rig 100 is configured to enable an artist to create animation sequence data. Animation sequence data is typically in the form of time series of data for control points of an object that has attributes that are controllable. In some examples the object includes a humanoid character with limbs and joints that are movable in manners similar to typical human movements.

Here, control rig 100 represents a humanoid character, but may be configured to represent a plurality of different characters. In an embodiment control rig 100 includes a hierarchical set of interconnected bones, connected by joints forming a kinematic chain.

For example, control rig 100 includes a thigh 102, a knee 104, a lower leg 106, an ankle 108, and a foot 110, connected by joints 112, 114. Control rig 100 may be employed to individually move individual bones and joints using forward kinematics to pose a character. Moving thigh 102 causes a movement of the lower leg 106, as the lower leg 106 is connected to the thigh via the knee 104. Thigh 102 and lower leg 106, for example, are in a parent-child relationship. Movement of the lower leg 106 is a product of movement of the thigh 102 as well as movement of the lower leg 106 itself. Control rig 100 may also use inverse kinematics, in which an artist moves ankle 108 for example. If an artist moves ankle 108 upwards, knee 104 consequently bends and moves upwards to accommodate a pose in which ankle 108 is at a user specified location.

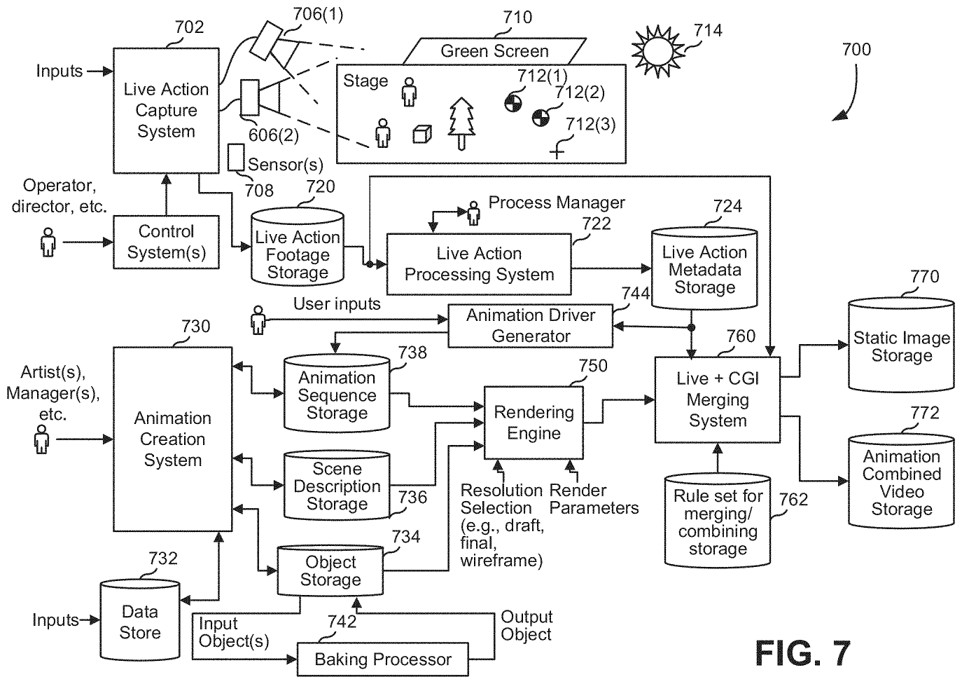

Control rig 100 may be formed using a plurality of data points. Control rig 100 may be matched to a skeleton obtained from an animation system, or from, for example, motion capture markers or other means on real-life actors. A live action scene of a human actor is captured by live action capture system 702 (see FIG. 7) while wearing mo-cap fiducials for example high-contrast markers outside actor clothing. The movement of those fiducials is determined by live action processing system 722. Animation driver generator 744 may convert that movement data into specifications of how joints of an articulated character are to move over time.

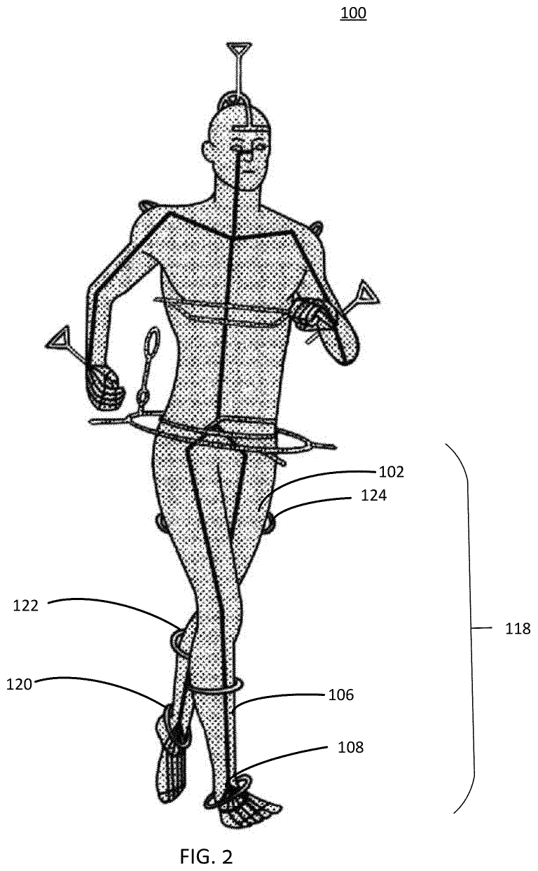

As shown in FIG. 2, control rig 100 includes a plurality of animation control points, or control points. Examples of control points are indicated at 120, 122 and 124 respectively. For example, in an embodiment control rig 100 includes control point 120 at the ankle that allows an animator to control the motion of a leg of control rig 100. In another example, control point 122 is positioned at a lower leg of the rig 100 and/or control point 124 is positioned at an upper leg. Different parts of the control rig 100 have associated to them respective control points.

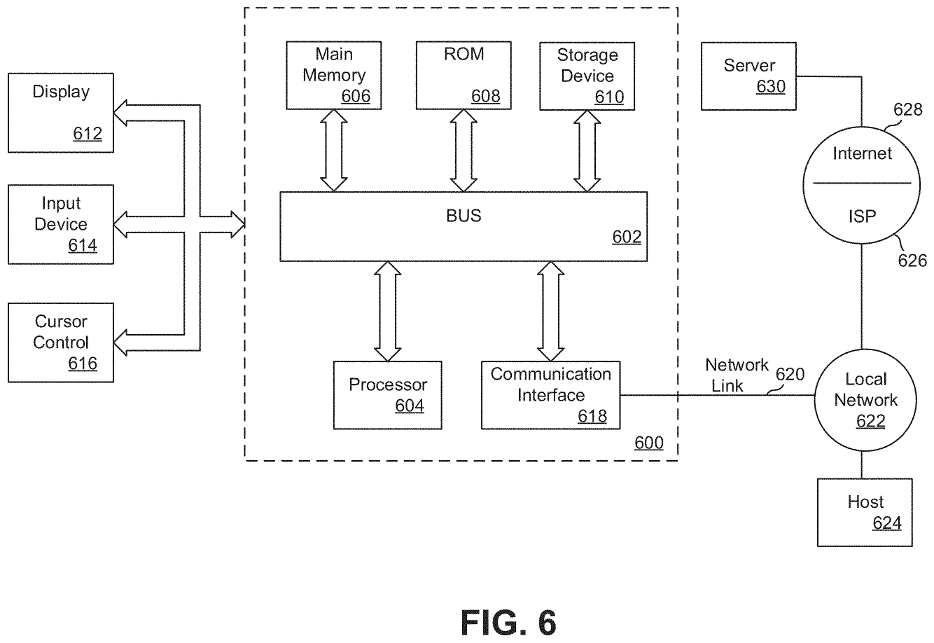

In an embodiment an artist creates an animation sequence by selecting a control point on the control rig. Control rig 100 may be displayed, for example, on display 612 (see FIG. 6). The artist selects a control point using input device 614 and/or cursor control 616. The control points may be displayed as extending from a character represented by control rig 100. Displaying the control points in this manner enables the artist to select a control point easily.

The artist may, for example, select control point 122 for the lower leg or control point 124 for the upper leg of control rig 100. The artist selects a position and/or location of the control point that is different to the current position and/or location of the control point. This process is known as key-framing. The artist moves controls to new positions at given times, thereby creating key poses in an animation sequence. Interpolation is performed between key poses.

In an embodiment, control points may be used to control more than one bone. For example, a control point may be used to control the upper arm and lower arm at the same time.

In an embodiment at least one inverse kinematics operation is performed in order to generate the animation sequence specified by the artist. For example, the artist may wish to specify that ankle 108 is to move from a location within control rig 100 shown in FIG. 1 to a location within control rig shown in FIG. 2. The artist manipulates control point 120 to specify a desired change in ankle location.

A series of calculations is performed to determine what changes in location and/or orientation of parts of control rig 100 are required to result in an orientation of control rig shown in FIG. 2. For example, the new location of control point 120 selected by the artist may require a change in location and/or orientation of at least the thigh 102, the knee 104, the lower leg 106, the ankle 108 and the foot 110. The changes in location and/or orientation that are required to achieve a goal of the artist are then determined.

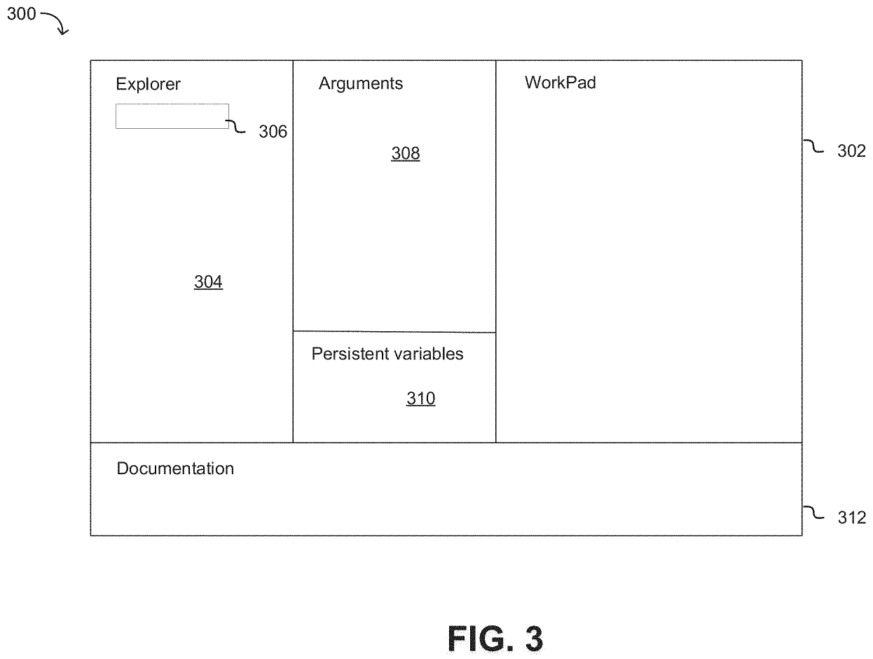

FIG. 3 shows an example of a user interface 300 that may be used to author evaluation logic and to generate an executable code object 612 (see FIG. 6) that may also be referred to herein as an evaluator. An executable code object 612 is defined herein as executable code that is derived from functions, calls, datatypes, arguments, variables (local or global variables), etc. The executable code object 612 may be compiled into a single execution block, or may be converted to any number of deferent types of compliable and executable codes such as C++, Python, etc. In an embodiment the execution block comprises source code and/or compiled code.

In some embodiments, executable code objects 612 may be used to generate blocks of executable code for execution before or during runtime. Such execution blocks may be generated to assist in increasing the speed and efficiency of operations pertaining to animation such as sketching, generating, animating, lighting, shading, etc.

In one example, interface 300 may be employed to create executable code objects 612 that may be used to operate animation controls, such as skeletal positions, and other controls, associated with an animation control rig, for example the animation control rig 100 illustrated in FIG. 1, and also may be used with other aspects of animation development such as lighting, physical simulation, etc. Animation controls may be defined and operated on using a Graphical User Interface (GUI) in an animation software package. The animation controls may then be passed as inputs to evaluation logic defined in interface 300.

In an embodiment user interface 300 is presented on a display, for example display 612 illustrated in FIG. 6. Inputs are received for example by a user operating input device 614 and/or cursor control 616.

In an embodiment the user interface includes a working canvas 302. Working canvas 302 is configured to receive evaluation logic from a user. Evaluation logic may include for example building blocks involving math, geometry, drawing and algorithms Evaluation logic may also include user authored functions written in a source language such as C++, Visual Basic, Python, and the like.

In an embodiment working canvas 302 is configured to enable the user to populate working canvas 302 using input device 614 (see FIG. 6) such as a keyboard or similar. The user may, for example, operate input device 614 to enter text into working canvas 302. The user may also select and copy text into main memory 606 and paste the copied text into working canvas 302.

Alternatively or additionally, working canvas 302 is configured to be populated by a user operating cursor control 616 and input device 614 to perform a drag-and-drop action on components from other windows or within user interface 300. These components may include graphical objects such as nodes from a visual graph, text, or a combination of graphical objects and text.

In an embodiment, working canvas 302 and other components within user interface 300 are configured to be populated by retrieving, from storage device 610 and/or main memory 606, data representing a stored executable code object.

Working canvas 302 may include controls configured to receive a user selection to expand or collapse at least some of the displayed lines of code. For example, the user may wish to expand all function calls so that they may be viewed in the working canvas 302. Alternatively, the user may wish to hide all entries in a conditional selection state. The user may select a control that causes at least some of the entries in the conditional to collapsed or hidden.

User interface 300 may include an explorer panel 304. The executable code entered into the working canvas 302 may include functions, datatypes, or the like. In an embodiment the explorer panel 304 includes search bar 306 that is configured to receive a user search query for at least one function or datatype. The search query is executed against a library of stored functions, datatypes, data, etc. The results of the user query may be displayed within the explorer panel 304, for example below the search bar 306.

In an embodiment, explorer panel 304 is configured to receive a user selection of a function or datatype that is included in the results of the user query. The selected function or datatype is able to be dragged by the user and dropped into working canvas 302. In an embodiment, working canvas 302 is configured to receive a user selection for the function or datatype of a location within the executable code displayed in working canvas 302. For example the user may drop the selected function, datatype, etc., at a selected location within the executable code.

User interface 300 may include arguments panel 308. This panel displays data that is visible to functions, modules and components having access to the executable code displayed in working canvas 302. Arguments panel 308 may display for example an argument name, whether or not the argument value is constant or mutable, an associated processor for example CPU, and a datatype for example ‘int’.

User interface 300 may include persistent variables panel 310 configured to display variables that are global in nature. In an embodiment, persistent variables remain in use and keep their respective values over multiple executions of the evaluation logic. Persistent variables are not typically shared between different characters.

User interface 300 may also include documentation panel 312. In an embodiment, documentation panel 312 displays any documentation associated with a selected function. For example, user interface 300 may receive a user selection of a function. Documentation panel 312 displays documentation associated with that user selected function.

In an embodiment the evaluation logic is executed in a linear fashion, e.g., from top to bottom. The evaluation logic displayed in working canvas 302 is packaged into an executable code object. Examples of how such executable code objects are manipulated are further described below.

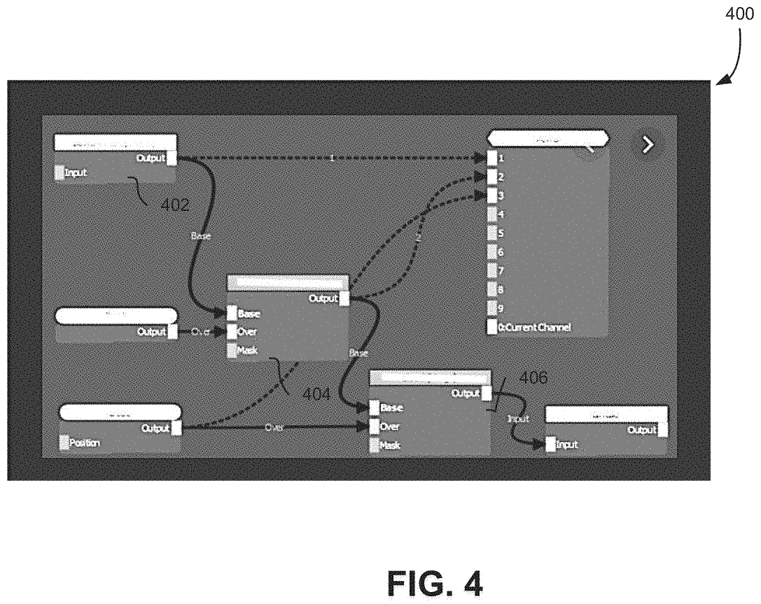

FIG. 4 shows an example of a hierarchical node graph 400 suitable for implementing control rig 100 of FIG. 1. Node graph 400 includes a plurality of nodes, examples of which are shown at 402, 404 and 406 respectively. At least some of the nodes are associated with at least one input and at least one output.

In an embodiment one or more nodes of the hierarchical node graph 400 represent respective animation control points of the control rig 100. Outputs from individual nodes include the solved positions of each joint angle and bone position in the kinematic chain. In inverse kinematics, the new joint angles and positions are determined relative to the control input. Inputs to the individual nodes include the new position of a member that is then used to calculate the position of the other members of the skeleton and the associated joint angles. For example, moving the hand from a first position resting on the ground to a new position above the ground will be used to determine the position of the forearm, upper arm, and elbow, and shoulder.

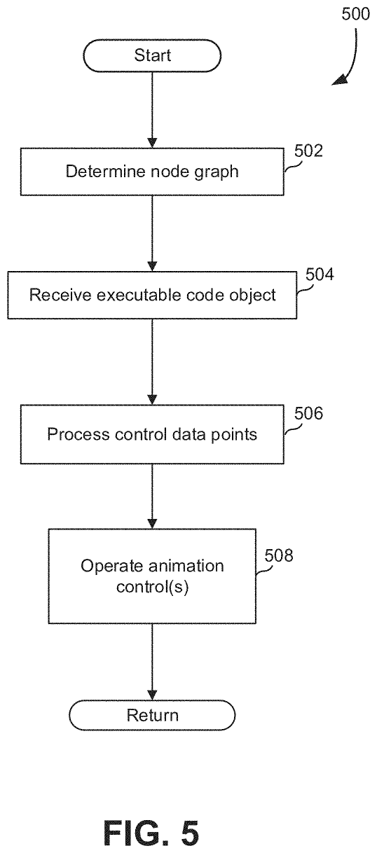

FIG. 5 shows an example of a method 500 for operating animation controls associated with an animation control rig, such as control rig 100 (see FIG. 1). The method manipulates an executable code object that may be generated for example from the workpad 302 of FIG. 3.

In an embodiment method 500 includes determining 502 a node graph used to operate one or more animation controls, for example node graph 400 (see FIG. 4). In an embodiment at least one node of the node graph includes a function employed to check a data type. In an embodiment at least one node of the node graph includes a function employed to check a data version.

An executable code object is received 504. In an embodiment the executable code object is received via a User Interface (UI) widget, for example user interface @3@00 (see FIG. @3@). In an embodiment the executable code object replaces part of a node graph, and is inserted via source code executed by the user operating input device 614 (see FIG. 6).

In an embodiment the executable code object is received by populating a window using input device 614 such as a keyboard or similar. A user may, for example, operate input device 614 to enter text into a window. The user may also select and copy text into main memory 606 and paste the copied text into a window.

Alternatively or additionally, a window within user interface @3 @00 is configured to be populated by a user operating cursor control 616 and input device 614 to perform a drag-and-drop action on components from other windows or within user interface @3@00.

In an embodiment, at least some of the components within user interface 300 are configured to be populated by retrieving, from storage device 610 and/or main memory 606, data representing the executable code object.

The executable code object is configured to replace at least two nodes disposed in the node graph at runtime. In an embodiment the executable code object is configured to execute animation control inputs used to control the one or more animation controls at runtime as a single execution block configured to merge at least two data evaluation processes into a single data evaluation process. The executable code object responds to animation control inputs, and so executes on control input changes.

In an embodiment the nodes disposed in the node graph are associated with respective data evaluation processes each having execution overhead. Merging at least two of the nodes in the node graph into a single node has the potential to reduce execution overhead by reducing the number of data evaluation processes required.

The method includes processing 506 the control data inputs using the executable code object.

The animation control(s) are operated 508 with respect to the single execution block in response to the control data inputs. In an embodiment, operating animation control(s) causes an animated object to be generated. The animated object may be displayed, for example on display 612, as an image sequence.

In an embodiment the method 500 may include receiving a request to break the executable code object into two or more segments. Where such a request is received, the method may include determining at least one segmentation point that reduces an increase in processing time incurred by segmenting the executable code object.

According to one embodiment, the techniques described herein are implemented by one or generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

For example, FIG. 6 is a block diagram that illustrates a computer system 600 upon which the systems and method described above and/or visual content generation system 7 (see FIG. 7) may be implemented. The computer system 600 includes a bus 602 or other communication mechanism for communicating information, and a processor 604 coupled with the bus 602 for processing information. The processor 604 may be, for example, a general purpose microprocessor.

The computer system 600 also includes a main memory 606, such as a random access memory (RAM) or other dynamic storage device, coupled to the bus 602 for storing information and instructions to be executed by the processor 604. The main memory 606 may also be used for storing temporary variables or other intermediate information during execution of instructions to be executed by the processor 604. Such instructions, when stored in non-transitory storage media accessible to the processor 604, render the computer system 600 into a special-purpose machine that is customized to perform the operations specified in the instructions.

The computer system 600 further includes a read only memory (ROM) 608 or other static storage device coupled to the bus 602 for storing static information and instructions for the processor 604. A storage device 610, such as a magnetic disk or optical disk, is provided and coupled to the bus 602 for storing information and instructions.

The computer system 600 may be coupled via the bus 602 to a display 612, such as a computer monitor, for displaying information to a computer user. An input device 614, including alphanumeric and other keys, is coupled to the bus 602 for communicating information and command selections to the processor 604. Another type of user input device is a cursor control 616, such as a mouse, a trackball, or cursor direction keys for communicating direction information and command selections to the processor 604 and for controlling cursor movement on the display 612. This input device typically has two degrees of freedom in two axes, a first axis (e.g., x) and a second axis (e.g., y), that allows the device to specify positions in a plane.

The computer system 600 may implement the techniques described herein using customized hard-wired logic, one or more ASICs or FPGAs, firmware and/or program logic which in combination with the computer system causes or programs the computer system 600 to be a special-purpose machine. According to one embodiment, the techniques herein are performed by the computer system 600 in response to the processor 604 executing one or more sequences of one or more instructions contained in the main memory 606. Such instructions may be read into the main memory 606 from another storage medium, such as the storage device 610. Execution of the sequences of instructions contained in the main memory 606 causes the processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as the storage device 610. Volatile media includes dynamic memory, such as the main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include the bus 602. Transmission media can also take the form of acoustic or light waves, such as those generated during radio-wave and infra-red data communications.

Various forms of media may be involved in carrying one or more sequences of one or more instructions to the processor 604 for execution. For example, the instructions may initially be carried on a magnetic disk or solid state drive of a remote computer. The remote computer can load the instructions into its dynamic memory and send the instructions over a network connection. A modem or network interface local to the computer system 600 can receive the data. The bus 602 carries the data to the main memory 606, from which the processor 604 retrieves and executes the instructions. The instructions received by the main memory 606 may optionally be stored on the storage device 610 either before or after execution by the processor 604.

The computer system 600 also includes a communication interface 618 coupled to the bus 602. The communication interface 618 provides a two-way data communication coupling to a network link 620 that is connected to a local network 622. For example, the communication interface 618 may be an integrated services digital network (ISDN) card, cable modem, satellite modem, or a modem to provide a data communication connection to a corresponding type of telephone line. Wireless links may also be implemented. In any such implementation, the communication interface 618 sends and receives electrical, electromagnetic, or optical signals that carry digital data streams representing various types of information.

The network link 620 typically provides data communication through one or more networks to other data devices. For example, the network link 620 may provide a connection through the local network 622 to a host computer 624 or to data equipment operated by an Internet Service Provider (ISP) 626. The ISP 626 in turn provides data communication services through the world wide packet data communication network now commonly referred to as the “Internet” 628. The local network 622 and Internet 628 both use electrical, electromagnetic, or optical signals that carry digital data streams. The signals through the various networks and the signals on the network link 620 and through the communication interface 618, which carry the digital data to and from the computer system 600, are example forms of transmission media.

The computer system 600 can send messages and receive data, including program code, through the network(s), the network link 620, and communication interface 618. In the Internet example, a server 630 might transmit a requested code for an application program through the Internet 628, ISP 626, local network 622, and communication interface 618. The received code may be executed by the processor 604 as it is received, and/or stored in the storage device 610, or other non-volatile storage for later execution.

For example, FIG. 7 illustrates the example visual content generation system 700 as might be used to generate imagery in the form of still images and/or video sequences of images. The visual content generation system 700 might generate imagery of live action scenes, computer generated scenes, or a combination thereof. In a practical system, users are provided with tools that allow them to specify, at high levels and low levels where necessary, what is to go into that imagery. For example, a user such as an animation artist might use the visual content generation system 700 to capture interaction between two human actors performing live on a sound stage and replace one of the human actors with a computer-generated anthropomorphic non-human being that behaves in ways that mimic the replaced human actor's movements and mannerisms, and then add in a third computer-generated character and background scene elements that are computer-generated, all in order to tell a desired story or generate desired imagery.

Still images that are output by the visual content generation system 700 might be represented in computer memory as pixel arrays, such as a two-dimensional array of pixel color values, each associated with a pixel having a position in a two-dimensional image array. Pixel color values might be represented by three or more (or fewer) color values per pixel, such as a red value, a green value, and a blue value (e.g., in RGB format). Dimension of such a two-dimensional array of pixel color values might correspond to a preferred and/or standard display scheme, such as 1920 pixel columns by 1280 pixel rows Images might or might not be stored in a compressed format, but either way, a desired image may be represented as a two-dimensional array of pixel color values. In another variation, images are represented by a pair of stereo images for three-dimensional presentations and in other variations, some or all of an image output might represent three-dimensional imagery instead of just two-dimensional views.

A stored video sequence might include a plurality of images such as the still images described above, but where each image of the plurality of images has a place in a timing sequence and the stored video sequence is arranged so that when each image is displayed in order, at a time indicated by the timing sequence, the display presents what appears to be moving and/or changing imagery. In one representation, each image of the plurality of images is a video frame having a specified frame number that corresponds to an amount of time that would elapse from when a video sequence begins playing until that specified frame is displayed. A frame rate might be used to describe how many frames of the stored video sequence are displayed per unit time. Example video sequences might include 24 frames per second (24 FPS), 50 FPS, 140 FPS, or other frame rates. In some embodiments, frames are interlaced or otherwise presented for display, but for the purpose of clarity of description, in some examples, it is assumed that a video frame has one specified display time and it should be understood that other variations are possible.

One method of creating a video sequence is to simply use a video camera to record a live action scene, i.e., events that physically occur and can be recorded by a video camera. The events being recorded can be events to be interpreted as viewed (such as seeing two human actors talk to each other) and/or can include events to be interpreted differently due to clever camera operations (such as moving actors about a stage to make one appear larger than the other despite the actors actually being of similar build, or using miniature objects with other miniature objects so as to be interpreted as a scene containing life-sized objects).

Creating video sequences for story-telling or other purposes often calls for scenes that cannot be created with live actors, such as a talking tree, an anthropomorphic object, space battles, and the like. Such video sequences might be generated computationally rather than capturing light from live scenes. In some instances, an entirety of a video sequence might be generated computationally, as in the case of a computer-animated feature film. In some video sequences, it is desirable to have some computer-generated imagery and some live action, perhaps with some careful merging of the two.

While computer-generated imagery might be creatable by manually specifying each color value for each pixel in each frame, this is likely too tedious to be practical. As a result, a creator uses various tools to specify the imagery at a higher level. As an example, an artist might specify the positions in a scene space, such as a three-dimensional coordinate system, of objects and/or lighting, as well as a camera viewpoint, and a camera view plane. Taking all of that as inputs, a rendering engine may compute each of the pixel values in each of the frames. In another example, an artist specifies position and movement of an articulated object having some specified texture rather than specifying the color of each pixel representing that articulated object in each frame.

In a specific example, a rendering engine performs ray tracing wherein a pixel color value is determined by computing which objects lie along a ray traced in the scene space from the camera viewpoint through a point or portion of the camera view plane that corresponds to that pixel. For example, a camera view plane might be represented as a rectangle having a position in the scene space that is divided into a grid corresponding to the pixels of the ultimate image to be generated, and if a ray defined by the camera viewpoint in the scene space and a given pixel in that grid first intersects a solid, opaque, blue object, that given pixel is assigned the color blue. Of course, for modern computer-generated imagery, determining pixel colors—and thereby generating imagery—can be more complicated, as there are lighting issues, reflections, interpolations, and other considerations.

As illustrated in FIG. 7, a live action capture system 702 captures a live scene that plays out on a stage 704. The live action capture system 702 is described herein in greater detail, but might include computer processing capabilities, image processing capabilities, one or more processors, program code storage for storing program instructions executable by the one or more processors, as well as user input devices and user output devices, not all of which are shown.

In a specific live action capture system, cameras 706(1) and 706(2) capture the scene, while in some systems, there might be other sensor(s) 708 that capture information from the live scene (e.g., infrared cameras, infrared sensors, motion capture (“mo-cap”) detectors, etc.). On the stage 704, there might be human actors, animal actors, inanimate objects, background objects, and possibly an object such as a green screen 710 that is designed to be captured in a live scene recording in such a way that it is easily overlaid with computer-generated imagery. The stage 704 might also contain objects that serve as fiducials, such as fiducials 712(1)-(3), that might be used post-capture to determine where an object was during capture. A live action scene might be illuminated by one or more lights, such as an overhead light 714.

During or following the capture of a live action scene, the live action capture system 702 might output live action footage to a live action footage storage 720. A live action processing system 722 might process live action footage to generate data about that live action footage and store that data into a live action metadata storage 724. The live action processing system 722 might include computer processing capabilities, image processing capabilities, one or more processors, program code storage for storing program instructions executable by the one or more processors, as well as user input devices and user output devices, not all of which are shown. The live action processing system 722 might process live action footage to determine boundaries of objects in a frame or multiple frames, determine locations of objects in a live action scene, where a camera was relative to some action, distances between moving objects and fiducials, etc. Where elements are sensored or detected, the metadata might include location, color, and intensity of the overhead light 714, as that might be useful in post-processing to match computer-generated lighting on objects that are computer-generated and overlaid on the live action footage. The live action processing system 722 might operate autonomously, perhaps based on predetermined program instructions, to generate and output the live action metadata upon receiving and inputting the live action footage. The live action footage can be camera-captured data as well as data from other sensors.

An animation creation system 730 is another part of the visual content generation system 700. The animation creation system 730 might include computer processing capabilities, image processing capabilities, one or more processors, program code storage for storing program instructions executable by the one or more processors, as well as user input devices and user output devices, not all of which are shown. The animation creation system 730 might be used by animation artists, managers, and others to specify details, perhaps programmatically and/or interactively, of imagery to be generated. From user input and data from a database or other data source, indicated as a data store 732, the animation creation system 730 might generate and output data representing objects (e.g., a horse, a human, a ball, a teapot, a cloud, a light source, a texture, etc.) to an object storage 734, generate and output data representing a scene into a scene description storage 736, and/or generate and output data representing animation sequences to an animation sequence storage 738.

Scene data might indicate locations of objects and other visual elements, values of their parameters, lighting, camera location, camera view plane, and other details that a rendering engine 750 might use to render CGI imagery. For example, scene data might include the locations of several articulated characters, background objects, lighting, etc. specified in a two-dimensional space, three-dimensional space, or other dimensional space (such as a 2.5-dimensional space, three-quarter dimensions, pseudo-3D spaces, etc.) along with locations of a camera viewpoint and view place from which to render imagery. For example, scene data might indicate that there is to be a red, fuzzy, talking dog in the right half of a video and a stationary tree in the left half of the video, all illuminated by a bright point light source that is above and behind the camera viewpoint. In some cases, the camera viewpoint is not explicit, but can be determined from a viewing frustum. In the case of imagery that is to be rendered to a rectangular view, the frustum would be a truncated pyramid. Other shapes for a rendered view are possible and the camera view plane could be different for different shapes.

The animation creation system 730 might be interactive, allowing a user to read in animation sequences, scene descriptions, object details, etc. and edit those, possibly returning them to storage to update or replace existing data. As an example, an operator might read in objects from object storage into a baking processor that would transform those objects into simpler forms and return those to the object storage 734 as new or different objects. For example, an operator might read in an object that has dozens of specified parameters (movable joints, color options, textures, etc.), select some values for those parameters and then save a baked object that is a simplified object with now fixed values for those parameters.

Rather than have to specify each detail of a scene, data from the data store 732 might be used to drive object presentation. For example, if an artist is creating an animation of a spaceship passing over the surface of the Earth, instead of manually drawing or specifying a coastline, the artist might specify that the animation creation system 730 is to read data from the data store 732 in a file containing coordinates of Earth coastlines and generate background elements of a scene using that coastline data.

Animation sequence data might be in the form of time series of data for control points of an object that has attributes that are controllable. For example, an object might be a humanoid character with limbs and joints that are movable in manners similar to typical human movements. An artist can specify an animation sequence at a high level, such as “the left hand moves from location (X1, Y1, Z1) to (X2, Y2, Z2) over time T1 to T2”, at a lower level (e.g., “move the elbow joint 2.5 degrees per frame”) or even at a very high level (e.g., “character A should move, consistent with the laws of physics that are given for this scene, from point P1 to point P2 along a specified path”).

Animation sequences in an animated scene might be specified by what happens in a live action scene. An animation driver generator 744 might read in live action metadata, such as data representing movements and positions of body parts of a live actor during a live action scene, and generate corresponding animation parameters to be stored in the animation sequence storage 738 for use in animating a CGI object. This can be useful where a live action scene of a human actor is captured while wearing mo-cap fiducials (e.g., high-contrast markers outside actor clothing, high-visibility paint on actor skin, face, etc.) and the movement of those fiducials is determined by the live action processing system 722. The animation driver generator 744 might convert that movement data into specifications of how joints of an articulated CGI character are to move over time.

A rendering engine 750 can read in animation sequences, scene descriptions, and object details, as well as rendering engine control inputs, such as a resolution selection and a set of rendering parameters. Resolution selection might be useful for an operator to control a trade-off between speed of rendering and clarity of detail, as speed might be more important than clarity for a movie maker to test a particular interaction or direction, while clarity might be more important that speed for a movie maker to generate data that will be used for final prints of feature films to be distributed. The rendering engine 750 might include computer processing capabilities, image processing capabilities, one or more processors, program code storage for storing program instructions executable by the one or more processors, as well as user input devices and user output devices, not all of which are shown.

The visual content generation system 700 can also include a merging system 760 that merges live footage with animated content. The live footage might be obtained and input by reading from the live action footage storage 720 to obtain live action footage, by reading from the live action metadata storage 724 to obtain details such as presumed segmentation in captured images segmenting objects in a live action scene from their background (perhaps aided by the fact that the green screen 710 was part of the live action scene), and by obtaining CGI imagery from the rendering engine 750.

A merging system 760 might also read data from a rulesets for merging/combining storage 762. A very simple example of a rule in a ruleset might be “obtain a full image including a two-dimensional pixel array from live footage, obtain a full image including a two-dimensional pixel array from the rendering engine 750, and output an image where each pixel is a corresponding pixel from the rendering engine 750 when the corresponding pixel in the live footage is a specific color of green, otherwise output a pixel value from the corresponding pixel in the live footage.”

The merging system 760 might include computer processing capabilities, image processing capabilities, one or more processors, program code storage for storing program instructions executable by the one or more processors, as well as user input devices and user output devices, not all of which are shown. The merging system 760 might operate autonomously, following programming instructions, or might have a user interface or programmatic interface over which an operator can control a merging process. In some embodiments, an operator can specify parameter values to use in a merging process and/or might specify specific tweaks to be made to an output of the merging system 760, such as modifying boundaries of segmented objects, inserting blurs to smooth out imperfections, or adding other effects. Based on its inputs, the merging system 760 can output an image to be stored in a static image storage 770 and/or a sequence of images in the form of video to be stored in an animated/combined video storage 772.

Thus, as described, the visual content generation system 700 can be used to generate video that combines live action with computer-generated animation using various components and tools, some of which are described in more detail herein. While the visual content generation system 700 might be useful for such combinations, with suitable settings, it can be used for outputting entirely live action footage or entirely CGI sequences. The code may also be provided and/or carried by a transitory computer readable medium, e.g., a transmission medium such as in the form of a signal transmitted over a network.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.

2. The computer-implemented method of claim 1, wherein at least one node of the node graph comprises a function employed to check a data type.

3. The computer-implemented method of claim 1, wherein at least one node of the node graph comprises a function employed to check a data version.

4. The computer-implemented method of any one of claim 1, further comprising:
in response to a request to break the executable code object into two or more segments, determining at least one segmentation point that reduces an increase in processing time incurred by segmenting the executable code object.

5. The computer-implemented method of claim 1, wherein the executable code object is received via a User Interface (UI) widget.

6. The computer-implemented method of claim 5, wherein the executable code object is received within the UI widget by a drag-and-drop action.

7. The computer-implemented method of claim 5, wherein the executable code object is received within the UI widget by retrieving, from a storage device, data representing the executable code object.

8. The computer-implemented method of claim 1 further comprising:
displaying the animated object on a display as an image sequence.

9. A computer system comprising:
one or more processors; and
a non-transient storage medium storing instructions, which when executed by the at least one processor, cause the system to implement a method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.

10. A non-transient storage medium storing instructions, which when executed by the at least one processor, cause the at least one processor to implement a method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.

11. A computer-implemented method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.

12. The computer-implemented method of claim 11, wherein at least one node of the node graph comprises a function employed to check a data type.

13. The computer-implemented method of claim 11, wherein at least one node of the node graph comprises a function employed to check a data version.

14. The computer-implemented method of claim 11, further comprising, in response to a request to break the executable code object into two or more segments, determining at least one segmentation point that reduces an increase in processing time incurred by segmenting the executable code object.

15. The computer-implemented method of claim 11, wherein the executable code object is received via a User Interface (UI) widget.

16. The computer-implemented method of claim 15, wherein the executable code object is received within the UI widget by one or more of: a drag-and-drop action, operation of an input device.

17. The computer-implemented method of claim 15, wherein the executable code object is received within the UI widget by retrieving, from a storage device, data representing the executable code object.

18. A computer system comprising:
one or more processors; and
a non-transient storage medium storing instructions, which when executed by the at least one processor, cause the system to implement a method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.

19. A non-transient storage medium storing instructions, which when executed by at least one processor, cause the at least one processor to implement a method for operating animation controls associated with an animation control rig, the method comprising:
determining a node graph used to operate one or more animation controls;
receiving an executable code object configured to replace at least two nodes disposed in the node graph at runtime, wherein the executable code object is configured to execute animation control inputs used to control the one or more animation controls at runtime as a single execution block configured to merge at least two data evaluation processes into a single data evaluation process to reduce execution overhead;
processing the control data inputs using the executable code object; and
operating the one or more animation controls with respect to the single execution instruction in response to the control data inputs.
